(19) United States
(12) Patent Application Publication
(10) Pub. No.: US 2003/0084106 A1
(43) Pub. Date: May 1, 2003

(54) Efficient transmission of multi-media contents as electronic mail

(75) Inventors: Ari Erev, Even Yohuda (IL); Eugene Neystadt, Kfar Saba (IL)

Correspondence Address: SUGHRUE MION, PLLC, 2100 Pennsylvania Avenue, N.W., Washington, DC, 20037-3213, US

(73) Assignee: COMVERSE, LTD.

(21) Appl. No.: 09/984,857

(22) Filed: Oct. 31, 2001

(51) Int. Cl. G06F 15/16

(52) U.S. Cl. 709/206; 709/219; 709/231

(57) ABSTRACT

A system and method for efficiently and conveniently sending time-related multi-media contents (MMC) over an e-mail system. In addition to the conventional bulk mode of transmitting MMC, as an attachment to (or possibly part of) an e-mail message, the method specifies a “reference mode transmission”, whereby, at least for part of the transmission path, the MMC themselves are temporarily stored in a media store while a reference to the storage (e.g. URI) is attached to the e-mail message, or embedded therein. The method is implementable as automatic processes in e-mail clients and e-mail servers. Various configurations are contemplated, whereby reference mode transmission occurs, in various combinations, over any of the path segments between the sending mail client, mail servers and the receiving mail client.

### FIELD OF THE INVENTION

This invention relates to sending multi-media contents as electronic mail (e-mail) over the Internet and, in particular, to a set of enhancements to conventional e-mail servers that allow efficient handling of multi-media content, especially streamable types (e.g. Audio, Video), in e-mail messages.

### BACKGROUND OF THE INVENTION

E-mail technology is based on the SMTP, POP3 and IMAP4 protocols which are widely recognized and used as Internet Standards. These protocols define the way mail systems work on the Internet. The basic message model they support is based on text. Optionally, any file may be attached to a message, then retrieved by the receiver of the message and opened at his computer, using an appropriate resident application program. Such an attached file, or “attachment”, may also be of a type that carries information for a human receiver in a modality other than text, notably as pictures, video or audio. These various modalities and similar ones are also referred to as media types and are collectively referred to as multi-media—especially in the context of the capability of a communication system, and terminals connected thereto (such as computers), to handle a variety of such media.

Of the various media types, audio and video are characterized primarily by the dimension of time. A file containing a digital representation of such media usually has the following characteristics: (1) it is relatively large (possibly several megabytes per minute of display time) and (2) it can assume any number of formats and structures (called “codecs”). In view of the first parameter, these formats and structures are usually designed so as to compress the data required for conveyance of the information; moreover, some of them are also designed so that the data can be “streamed” to the client, which means that the data can be sent at, or near, their natural time rate for nearly immediate viewing (or listening), obviating the need for buffer storage of any substantial portion of a file. The same technique may also be used for sending multi-media data from a client to a storage, when the data are created in real time (as, for example, by a video camera or by a sound pick-up system). In view of the diversity of the bandwidth available for transmission of a multi-media file over the various possible paths, some of the streaming structures are adaptive to the available bandwidth, so that the entire file can be transmitted over any given bandwidth at the full time rate, though with varying quality of reproduction. Also, because of diverse standards prevailing over various segments of a multi-media storage and transmission system, it may often be required to convert (transcode) data among the various formats and codecs. It is also noted that files of media not related to time may be formatted so as to be flexible with respect to the required transmission time.

Conventional e-mail systems handle multi-media files just like any other data files, usually carrying them as attachments, and do not support any mechanisms that handle the special characteristics of audio and video content, especially those relating to time. In particular, they do not support streaming operation, and thus require the entire transmitted file to be received and stored before becoming available for viewing or listening. Moreover, conventional e-mail systems do not by themselves provide any flexibility in the formatting of the data so as to conform to a given bandwidth, thus requiring that the data be always transmitted at minimum compression, if all levels of reproduction quality are to be anticipated, which results in inefficiency. The need for waiting until the entire file has been received, which may sometimes take many minutes (because of the amount of data and the minimal compression), makes reception of multi-media contents over e-mail inconvenient, at best, and impractical, under some circumstances. Moreover, certain types of reception terminals, such as Internet-enabled personal digital assistants (PDAs), may not have the required storage capacity. Similarly also certain types of transmitting terminals, such as Internet-enabled video cameras, may not have the required digital storage capacity required to send such files in the asynchronous SMTP protocol.

Within the present state of the art, if a person wishes to send multi-media contents (MMC) to another person at a remote network terminal, in a streaming fashion, the MMC may be streamed from an originating device to a storage (either local or at some Internet node), using a so-called streaming server, in cooperation with a locally resident so-called streaming client. He would then manually insert a reference to the location of the storage, such as its Universal Reference Identifier (URI), into an e-mail message and send the latter to the intended recipient. The sender could convey the storage location to the recipient also in alternative ways, such as by telephone. The recipient would then typically copy the reference into a streaming client (also known as media player) resident at his terminal and command it to address the storage and, in cooperation with a streaming server, which must be specified, to stream down the MMC. Alternatively, if the sender has the total MMC already stored (locally or at a remote node, to which the data may have been transferred using regular file transfer), the sender may just insert a reference to that location into an e-mail message.

Such procedures, though possible, are inconvenient and cumbersome, since they require active intervention by the sending and receiving persons. Such intervention is required in manually activating the streaming clients and, in the case of the sending terminal, in manually conveying the storage location reference. Moreover, the user will, in general, also have to add to the message information about the streaming format and similar parameters.

There is thus a clear need for a method and system of transmitting multi-media contents, especially of time-related types, over the Internet in association with e-mail messaging systems, that will be efficient and flexible and, in particular, will allow time-related contents to be transmitted in a bandwidth-adaptive streaming fashion, allowing the ultimate user to receive it with minimal delay—all that, in an automatic manner, requiring minimal intervention by the user and being independent of the data's original format and of the particular reproduction software available at the receiving terminal.

Emblaze Systems (formerly: Geo Interactive) of Tel-Aviv, Israel offers a demo system, based on their Wireless Media Platform (http://www.emblaze.com/images/flash/demo.swf), for integrating streaming technology with e-mail operation. This system is based on adding a streaming server software package to the e-mail server and the required support software for streaming (coded in Java)—to the Web-based e-mail client. This system has several disadvantages: (1) it is limited to the specific streaming software installed in the e-mail server and client; (2) streaming occurs only between the receiving client and its e-mail server and not between the client and any media store in the network; and (3) no streaming is provided for a sender of multi-media in association with e-mail, nor is there a streaming mode in the transmission between servers; thus no efficiencies are realized over these other links, where the data is sent as regular bulk files.

### SUMMARY OF THE INVENTION

The invention overcomes the drawbacks of prior-art methods and systems, by providing a method for efficiently and conveniently sending time-related multi-media contents (MMC) over an e-mail system, as well as of a system and its components that enable such a method. The method generally affects the entire transmission path, from the sending mail client, through the sending mail server and the receiving mail server to the receiving mail client. In addition to the conventional bulk mode of transmitting MMC, as an attachment to (or possibly part of) an e-mail message, the method specifies a “reference mode transmission”, whereby, at least for part of the transmission path, the MMC themselves are temporarily stored in a media store while a reference to the storage (e.g. URI) is attached to the e-mail message, or embedded therein.

Various configurations are contemplated, whereby reference mode transmission occurs, in various combinations, over any of the path segments between the mentioned mail clients and servers, that is—at any of the three stages of e-mail transmission. Common to most of the configurations is reference mode transmission from a mail server to the receiving mail client. The client, upon receiving a reference to a media store in a message, automatically activates a streaming client and a streaming server to downstream the data from the store to the receiving terminal for immediate viewing or listening. Thus the efficiency of streaming multi-media data is added to the e-mail reception capability, with the additional convenience of short message latency and not requiring any user interaction in the process. Moreover, any streaming server accessible over the network may be employed, thus enabling reception of MMC in any prevailing format and according to any known codec.

In certain configurations, there is also provision for an originator of MMC to send them out in streaming fashion. This is not only efficient, but may be the only possible way for certain types of MMC originating equipment that does not have enough storage space to store the data prior to sending the e-mail message, as would be required under conventional MMC e-mail transmission methods (e.g. as attachments). To this end, the method of the invention specifies reference-mode transmission from the sender's e-mail client to the e-mail server, whereby the multi-media data are streamed up to a media store, using any accessible streaming server, while a reference to the storage is automatically, and therefore conveniently, embedded in the message.

Further according to the invention, MMC originating in reference mode may be received by an e-mail client either in reference mode (as outlined above) or in conventional bulk mode (whereby the data are attached to, or imbedded in, the e-mail message). Also conversely, a MMC-related message arriving at a mail client in reference mode may have originated either in reference mode or, conventionally, in bulk mode. To this end, e-mail servers according to the invention are capable of (a) separating multi-media data from a conventional MMC-carrying message and uploading the data to a media store while embedding in the message a reference to the store, and/or (b) doing the inverse conversion of downloading multi-media data from a referenced media store and attaching the data to the message. Employing these conversion capabilities in the sending and/or receiving e-mail servers also gives rise to an ability to specify for any e-mail system whether MMC carrying messages be transmitted between the servers in reference mode or in bulk mode, regardless of the modes in the sending and receiving stages. Inter-server reference mode transmission results in high efficiency and short latency, though it requires security—and lifetime management of the stored data; (lifetime management means erasing the data from the store after a given period of time or according to some other conditions).

Any e-mail server or client may be configured to possess any combination of the corresponding capabilities specified by the invention.

Specifically, one embodiment of the invention is of a method for sending multi-media contents, in association with an e-mail message, from a sending terminal over a network to a receiving terminal, wherein the receiving terminal includes a receiving e-mail client and a streaming client and the network is also communicative with at least one media store; the method comprising:

(a) sending the e-mail message from the sending terminal;

(b) storing the multi-media contents at a location in a media store;

(c) embedding in the e-mail message a reference to the location;

(d) receiving the e-mail message at the receiving terminal; and

(e) causing the receiving e-mail client, after receiving the message, to extract the reference therefrom and to automatically activate the streaming client so as to address the media store according to the extracted reference and to transfer the corresponding multi-media contents from the media store in a streaming fashion.

Further, according to another embodiment of the invention, the e-mail message is transmitted through at least one e-mail server, communicative with the network, and (b) and (c) are each performed by an e-mail server and in (e), the transferring is by means of a streaming server communicative with the network and selectable by the receiving client.

In another configuration, the invention is of a method for sending multi-media contents, in association with an e-mail message, from a sending terminal over a network to a receiving terminal, the network being also communicative with at least one media store; the method comprising:

(a) sending the multi-media contents from the sending terminal in a streaming fashion to a media store, to be stored at a location therein;

(b) at the sending terminal automatically embedding in the e-mail message a reference to the location of (a);

(c) sending the e-mail message from the sending terminal;

(d) receiving the e-mail message at the receiving terminal;

(e) at the receiving terminal automatically extracting from the received e-mail message a reference to a location in a media store; and

(f) automatically causing the multi-media contents to be sent from the media store referred to by the extracted reference of (e), to the receiving terminal in a streaming fashion.

According to a further feature of this configuration, sending the multi-media contents is by means of any streaming server communicative with the network

In a further configuration the invention is of a method for sending multi-media contents, in association with an e-mail message, from a sending terminal over a network to a receiving terminal, wherein the e-mail message is transmitted through at least one e-mail server and the network is also communicative with at least one media store, the method comprising:

(a) at the sending terminal, embedding the multi-media contents in the message or attaching the multi-media contents to the message;

(b) sending the e-mail message, with the multi-media contents embedded or attached thereto, from the sending terminal;

(c) causing an e-mail server that receives the message of (a) to extract the multi-media contents therefrom, to store the extracted contents at a location in a media store and to embed in the e-mail message a reference to the location;

(d) receiving the e-mail message at the receiving terminal;

(e) at the receiving terminal automatically extracting from the received e-mail message a reference to a location in a media store; and

(f) automatically causing the multi-media contents to be sent from the media store referred to by the extracted reference of (e), to the receiving terminal in a streaming fashion.

According to further features of this configuration, the multi-media contents are sent by means of a streaming server communicative with the network and automatically selected by the receiving terminal and the streaming server may be of any of a number of different types.

In yet another configuration the invention is of a method for sending multi-media contents, in association with an e-mail message, from a sending terminal over a network to a receiving terminal, wherein the e-mail message is transmitted through at least one e-mail server and the network is also communicative with at least one media store, the method comprising:

(a) sending the multi-media contents from the sending e-mail client in a streaming fashion to a media store, to be stored at a location therein;

(b) at the sending terminal automatically embedding in the e-mail message a reference to the location;

(c) sending the e-mail message from the sending terminal;

(d) causing an e-mail server that receives the e-mail message with the embedded reference to extract the reference therefrom, to automatically transfer from the media store the multi-media contents corresponding to the extracted reference and to attach the multi-media contents to the message; and

(e) receiving the e-mail message, with the attached multi-media contents, at the receiving terminal.

According to further features of the configuration, the sending terminal includes an e-mail client, and wherein (a) and (b) are performed upon command from the e-mail client, the streaming server may be of any of a number of different types and (c) additionally includes causing the e-mail server to convert the format of the multi-media contents.

In another aspect, the invention is of a digital device, for sending therefrom multi-media contents, in association with an e-mail message, over a network, with which it communicates, the network being also communicative with at least one media store, the device comprising a streaming client and an e-mail client that is configured to:

cooperate with the streaming client in transferring the multi-media contents from the device in a streaming fashion to a media store, to be stored at a location therein; and

automatically embed in the e-mail message a reference to the location.

According to further features of this aspect of the invention, the device further comprises a plurality of streaming servers communicative with the network, wherein the e-mail client is further configured to select one of the streaming servers for cooperating with the selected streaming server in transferring the multi-media contents and to issue a command to the streaming client, which command causes the streaming client to address a media store and to send the multi-media contents thereto in a streaming fashion.

Another configuration of this aspect of the invention is a digital device, for receiving multi-media contents, in association with an e-mail message, over a network, with which it communicates, the multi-media contents being stored at a location in a media store communicative with the network, and the message including a reference to the location in the media store, the device comprising a streaming client and an e-mail client that is configured to automatically extract the reference from the e-mail message, the e-mail client being further configured to cause the streaming client to receive the multi-media contents from the media store, according to the extracted reference, in a streaming fashion.

A further aspect of the invention is a computing device, communicative with a network, for forwarding an incoming e-mail message in association with multi-media contents, the multi-media contents being stored at a location in a media store communicative with the network and the incoming message including a reference to the location in the media store, the device comprising:

a message input module, for receiving the incoming e-mail message;

a processor, cooperative with the input module and configured to automatically

extract the reference from the incoming message,

cause the multi-media contents to be transferred from the media store, according to the extracted reference, to the device,

attach the transferred multi-media contents to the message, and

forward the message with the attached multi-media contents; and

a message output module, responsive to the processor and configured to send along the e-mail message with any multi-media contents attached thereto.

Another configuration of this aspect of the invention is a computing device, communicative with a network, for forwarding an incoming e-mail message in association with multi-media contents, the multi-media contents being attached to the incoming message and the network being also communicative with at least one media store, the device comprising:

a message input module, for receiving the incoming e-mail message;

a processor, cooperative with the input module and configured to automatically

separate the multi-media contents from the incoming message, to form a multi-media data file,

transfer the data file to a location in a media store,

attach to, or imbed in, the message that remains after the separation a reference to the location, and

forward the message with the reference; and

a message output module, responsive to the processor and configured to send along the e-mail message with any reference imbedded therein.

Yet another aspect of the invention is of a computer program product comprising a computer useable medium having computer readable program code embedded therein for carrying out any of the methods disclosed hereinabove.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic block diagram of a basic conventional e-mail system, showing typical stations in the path of a message;

FIG. 2 is a schematic block diagram of an e-mail system according to the invention, showing alternative processes in the various stations and alternative transmission modes between them;

FIG. 3 is a table that contains a key to the processes of FIG. 2;

FIG. 4 is a flow chart for the processing of messages in an e-mail server according to one configuration of the invention; and

FIG. 5 is a flow chart for the processing of messages in an e-mail server according to another configuration of the invention.

### DETAILED DESCRIPTION OF THE PREFERRED EMBODIMENTS

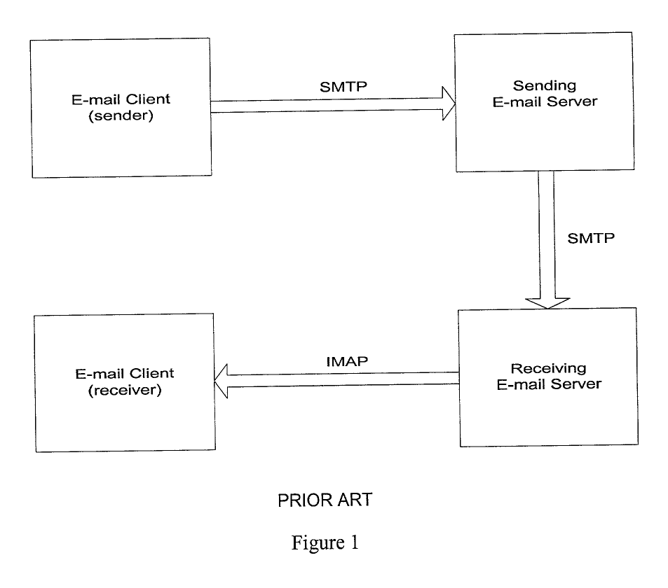

Generally, there are four significant stations involved in the generation and delivery of an e-mail message over a network, such as the Internet. These are, in the order of message transmission, the sending mail client, the sending mail server, the receiving mail server and the receiving mail client, as shown in FIG. 1.

A sending mail client may reside in any digital device that is interactive with a user and communicative with the network. Usually it creates an e-mail message and sends it, using SMTP protocol, to the sending mail server. There are also cases where the sending mail client interacts with a Web-based HTTP application that creates the message and sends it on behalf of the client. The digital device, to be referred to as the sending terminal, usually is a personal computer, but may also be a small portable device, such as a PDA or a cellular phone, or a media input or output device that has been adapted to communicate with the network, such as a digital camera, a video player, a telephone or any other audio device.

A receiving mail client may reside in any digital device that is interactive with a user and communicative with the network, and which is capable of receiving and handling an e-mail message, usually for display to the user. Reception is usually by means of the IMAP or POP e-mail protocol, though it may also be through a Web-based HTTP application. The digital device, to be referred to as the receiving terminal, usually is a personal computer, but may also be a small portable device, such as a PDA or a cellular phone, or a media input or output device that has been adapted to communicate with the network, such as a video display or recording device, a telephone or any other audio device.

A sending mail server is an e-mail server that can receive e-mail messages from a sending mail client and forward them, i.e. send them on their way to the final destination, using the SMTP protocol.

A receiving mail server is an e-mail server with which a receiving e-mail client is associated and that receives a mail message (using SMTP) on behalf of the client. It allows users of the client to browse messages while the messages reside on the server, and to download them, through the POP and IMAP mail protocols.

An e-mail message is sent over the network from the sending mail client, in a first stage of transmission, to the sending mail server, and thence, in a second stage of transmission, to the receiving mail server, possibly through intermediate mail servers, and finally, in a third stage of transmission, to the receiving mail client.

The present invention does not address the intermediate mail servers, assuming them to forward all messages unchanged. It is noted that a sending mail server and a receiving mail server may physically reside together, but in the present context they are functionally distinct. It is further noted that each mail server usually communicates with a plurality of corresponding mail clients, but the present discussion concentrates on a single sending client and a single receiving client for illustrative simplicity. It should be understood that the invention is also applicable to any or all of the other clients, as well as to other mail servers in a system and to their clients. The transmission at each stage is according to accepted e-mail protocols, such as SMTP, POP and IMAP (the latter two for the third stage) and these, as well as others, may continue to be used in systems embodying the invention.

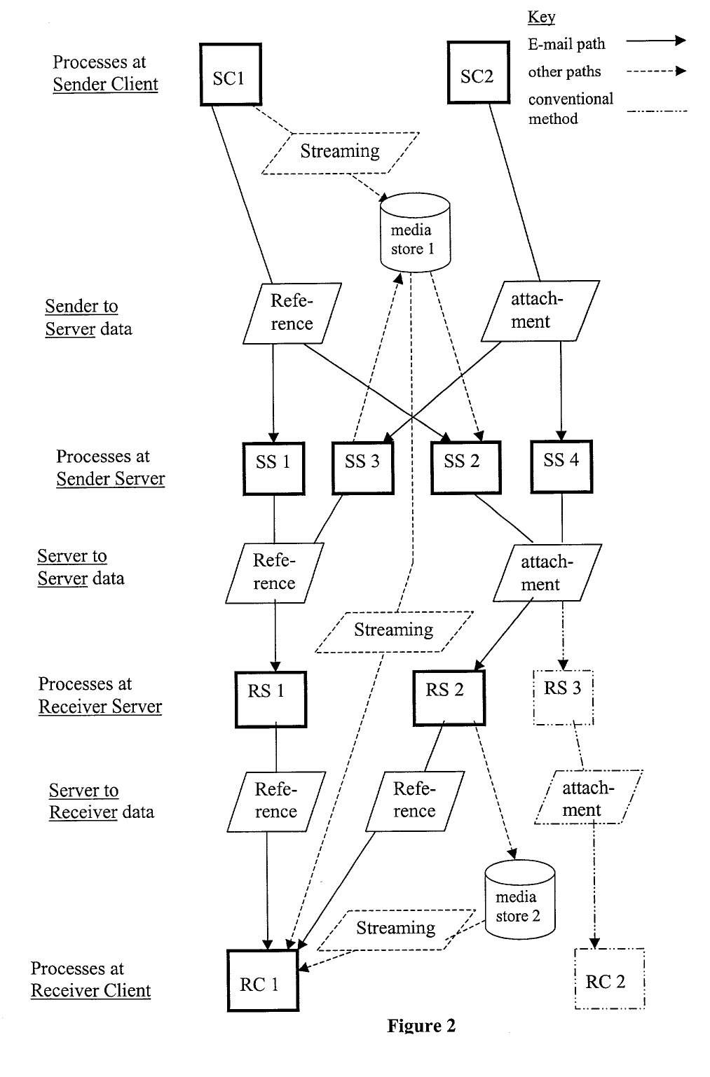

The preferred embodiments of the invention entail additional capabilities within any of the four nodes mentioned above, required for efficient and convenient transmission of multi-media contents (MMC) in association with e-mail messages. Several configurations are contemplated, reflecting various combinations of transmission modes of the MMC over the three stages of transmission between the four nodes. These configurations are depicted schematically as alternative paths in the block diagram of FIG. 2, which will be explained further below.

There are basically two MMC transmission modes possible over each of the three stages: bulk mode and reference mode. In bulk mode, the full multi-media data is sent along with the e-mail message as one or more attached files. Note that this is the conventional mode of sending MMC over an e-mail system, except that in the context of the invention, bulk mode transmission occurs over, at most, two of the three stages; whereas, in conventional systems it occurs over all three stages. In the reference mode, the multi-media data is sent in the first stage, from the sending terminal, in a streaming fashion to a so-called media store, using a streaming server (interfaced with the media store) and a streaming client, the latter residing in the sending terminal. A reference to the media store and to the location of the multi-media data stored therein (to be collectively referred to as a reference to the location) is attached to, or imbedded in, the transmitted e-mail message. Similarly in the reference mode, the multi-media data is sent in the third stage, to a receiving terminal, in a streaming fashion from a media store, using a streaming server and a streaming client, the latter residing in the receiving terminal. During the second stage, MMC associated with an e-mail message may be transferred between a media store and an e-mail server as a file. The reference is preferably in the form of a Universal Reference Identifier (URI) code, prevalent in the Internet. Also attached to, or embedded in, the message is an indication as to the particular streaming format, or type of codec, used. It is a characteristic of the invention that the MMC is conveyed in at least one of the three stages in a reference mode.

It is convenient to send out MMC from a sending e-mail client in a reference mode under a variety of circumstances. An important one is when the sending terminal does not have sufficient storage for the multi-media data, which is typical for contents generating devices such as telephones, cameras and sound recorders. It is convenient to receive MMC by a receiving e-mail client in a reference mode whenever it is desired to be able to immediately view, or hear, it. The invention, however, contemplates receiving MMC by an e-mail client also in bulk mode for the case that a streaming server is not available or that the user prefers storing the data locally and viewing it later, using a conventional media player. In a certain configuration, the invention also provides for a mail client that does not at all have the capability of receiving MMC in reference mode.

In order to be able to send out MMC in reference mode, according to the invention, the sending e-mail client preferably has the following additional capabilities. First, it has in storage, or is capable of receiving from an external source, the address of an appropriate media store, which may be at the sending terminal or at any node in the network.

Second, it has in storage, or is capable of receiving from an external source, the address of a streaming server. This may be at the same node as the media store or the sending e-mail server (or both, if sharing a node) or at any other node in the network. Optionally the addresses of several streaming servers may be thus available, the various servers being appropriate for various types of media and codecs.

Third, there is a streaming client resident at the sending terminal and capable of transmitting the MMC from its source to the streaming server. Fourth, the e-mail client is able, in response to an appropriate command from the user, to (a) automatically activate the streaming client, causing it to connect with a streaming server, to make the streaming server address the media store and to initiate the data transfer process; (b) obtain from the streaming client the location of the multi-media data in the media store; and (c) imbed or attach to a composed message a reference to the stored media, the reference containing the internet address of the media store and the location of the data therein, as well as preferably an indication of the multi-media type and of the suitable codec. It is noted that including the type of the multi-media or the codec in the reference and subsequently detecting it by the receiving client is an optional feature of the invention, its importance lying, for example, in the fact that downloading in the “wrong” codec/format may entail moving a lot of data through the network, whereas another codec/format may be much more suitable to a specific client.

In an alternative version of this fourth capability, the user may directly interact with the streaming client, which is modified to cooperate with the e-mail client and to exchange the required addresses with it. Note that the capabilities recounted above make the sending of MMC over the e-mail system differ from conventional procedures, in which the streaming transmission and the sending of an e-mail message are two separate processes that must be individually initiated and controlled by the user, who would also have to enter the location of the stored data into the message manually. By contrast, the procedure according to the invention is largely integrated and automatic.

In order to be able to receive MMC in reference mode, according to the invention, the receiving e-mail client preferably has the following additional capabilities. First, it has in storage, or is capable of receiving from an external source, the address of one or more streaming servers. Any of these may be at the receiving terminal or at any node in the network. The various streaming servers are operative for various multi-media types and corresponding codecs.

Second, there is a streaming client resident at the receiving terminal and capable of communicating with an appropriate reproduction device (replacing a conventional media player. Third, the e-mail client is able to (a) automatically detect in the incoming message the presence of a reference to stored multi-media contents, to extract therefrom the relevant location and to convey the latter to the streaming client; and (b) automatically activate the streaming client, causing it to connect with the streaming server, to make the streaming server address the media store, according to the extracted location, and to initiate the data transfer process. The particular streaming server addressed (if there is more than one) is determined by the e-mail client based on the type indication included with the reference embedded in the message, as has been explained above. For the case that the resident streaming client (e.g. on a cellular phone) is not capable of receiving the indicated data format, as it supports only one streaming codec/format, the invention contemplates an optional capability by the e-mail server to appropriately convert the format of the down streamed data.

Note that the capabilities recounted above also make the receiving of MMC over the e-mail system differ from conventional procedures, in which the streaming transmission and the receiving of an e-mail message are two separate processes that must be individually initiated and controlled by the user, who would also have to read the location of the stored data from the message and to enter it manually into the streaming client. By contrast, the procedure according to the invention is, again, largely integrated and automatic. Also note that, as with most other streaming applications, the rate of streaming data is adjusted according to the current transmission bandwidth, to obtain the optimal possible reproduction quality. The invention makes this advantageous feature, not possible with conventional bulk transmission of MMC, available more conveniently.

The invention also contemplates transforming MMC between the two transmission modes, the transformation taking place at the mail server between the two relevant transmission stages. It may be performed, with respect to any e-mail message, either upon reception of the message or just prior to sending the message along. For transforming from bulk mode to reference mode, the server has the additional capabilities of separating the multi-media data from the message, usually from the attached file, and sending the data to an appropriate media store, while embedding into the message, or, preferably, attaching to it (in place of the multi-media data) a reference to the stored data (e.g. a URI). The media store may be at the same node as the mail server or at any other node in the network.

For transforming from reference mode to bulk mode, the server has the additional capabilities of reading the reference (e.g. the URI) in the received message, addressing the referenced media store, transferring (downloading) the indicated multi-media data, and attaching the same to the message, instead of the reference. An additional important capability of the system is conversion of data between various file formats of multi-media data and the various codecs for streamed data. This capability may reside in a mail server, in conjunction with the mode transformation function, or it may reside in a streaming server. Note that this capability makes the issue of format compatibility over the e-mail system transparent to the end users.

FIG. 2 depicts schematically the alternative processes contemplated in each of the four stations associated with the e-mail transmission and the corresponding data paths at the three transmission stages between the stations, according to various configurations of the invention. The processes, represented by heavy rectangles 22, are shown in horizontal rows corresponding to the stations, as marked on the left. The regions between them are designated on the left as to the respective transmission stages that they represent.

Possible paths of e-mail messages are represented by solid lines, with type of data carried by the messages indicated in superimposed parallelograms 24. For bulk mode transmission, the type of data is “attachment” (though it is meant to include also multi-media data imbedded in the message), while for reference mode, the transmitted data is “reference”, indicating the reference to the media store attached to, or imbedded in, the e-mail message. Paths of multi-media data in reference mode are represented by dashed lines, whereby parallelograms marked “streaming” indicate paths over which the data is actually streamed (the other dashed-line paths denoting conventional data transfers). The two storage symbols 26, marked “media store 1” and “media store 2” represent any number of media stores that may be used in the system.

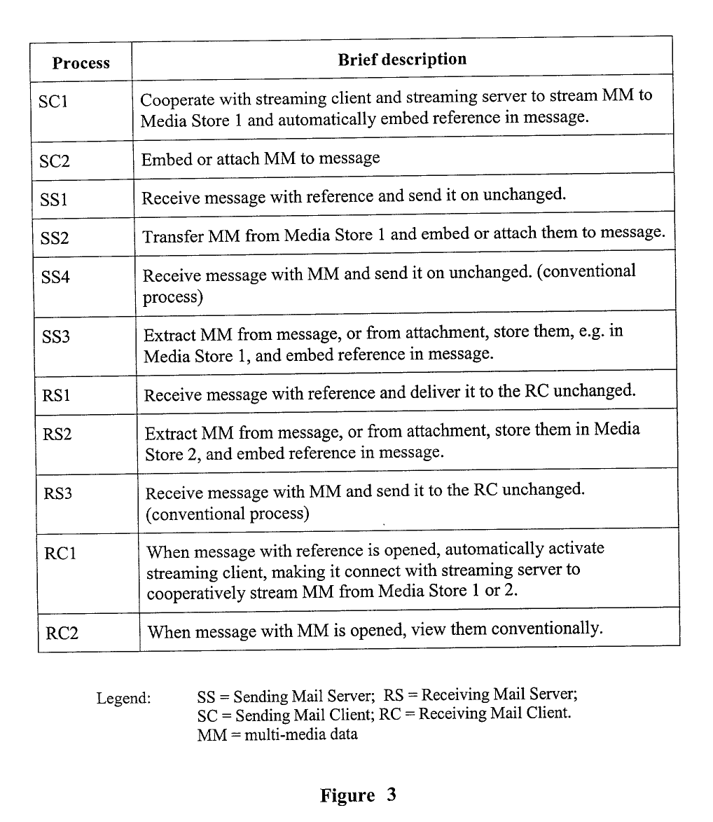

The designations of the various processes, marked inside the rectangles, will be used as references in the explanations that follow. Generally, SC indicates a process in the sending mail client while SS generally indicates a process in the sending mail server. Likewise, RS generally indicates a process in the receiving mail server, and RC—a process in the receiving mail client. The processes are briefly described in the key table of FIG. 3.

Most of the configurations include reference mode transmission at the third stage and thus involve process RC1, which will therefore be described first. The receiving e-mail client examines messages received from the receiving e-mail server and opened by the user. When a message that contains (possibly as attachment) a reference to a media store is opened, the e-mail client automatically, possibly after an approval indication from the user, activates the streaming client in the node, conveying to it the referenced URI, as well as the type and format of the multi-media data and the address of an appropriate streaming server. In response, the streaming client connects to the streaming server, forwarding to it the referenced URI. The streaming server then connects to the referenced media store and commences streaming down the multi-media data from the referenced location. The streamed data is then handled by the streaming client in the usual manner to effect the desired reproduction.

Of the above, one set of configurations includes reference mode transmission also at the second stage. These configurations involve the process RS1, which consists of the trivial operation in the receiving mail server of transmitting the message with the attached (or imbedded) reference unchanged, as received from the sending mail server, while the multi-media data remain stored in the media store (represented in FIG. 2 by “media store 1”). One of these configurations, to be referred to as configuration A, includes reference mode transmission also at the first stage and thus involves process SS1 in the sending mail server, which also consists of the trivial operation of transmitting the message with the attached (or imbedded) reference unchanged, in this case, as received from the sending mail client. The operation at the sending mail client that generates the message in the reference mode (process SC1) is described below. The other configuration that includes reference mode transmission at the second stage, to be referred to as configuration B, includes bulk mode transmission at the first stage and involves process SS3 in the sending mail server. This process separates the multi-media data from the message or from an attachment, stores the data in a media store, e.g. in media store 1 (as shown in FIG. 2 ) or media store 2, and embeds in the message (or attaches to it) a reference to this storage. The process may also include format conversion of the data prior to storing. The choice of a particular media store depends on system parameters. In general it is preferable to select a media store that has the widest, or at least adequate, transmission bandwidth to the receiving mail client or to the streaming server that may be used by the receiving mail client. The bulk mode transmission of multi-media data in the first stage is initiated by the sending mail client in process SC2, which is the conventional process of sending MMC over the e-mail system.

The other set of configurations whose third-stage transmission is in reference mode includes bulk mode transmission in the second stage and thus involves process RS2 in the receiving mail server. Process RS2, which converts the transmission mode from bulk to streaming, is similar to process SS3, described above, whereby, in the illustrated case, it stores the multi-media data in media store 2.

One of these configurations, to be referred to as configuration C, includes reference mode transmission at the first stage and thus involves process SS2 in the sending mail server. Process SS2, which serves to convert the transmission mode from streaming to bulk, comprises extracting the URI of the multi-media data from the reference in the message, downloading the data from the referenced media store (in the illustrated case, media store 1) and embedding or attaching them to the message, instead of the reference. The other configuration with bulk mode transmission in the second stage, to be referred to as configuration D, has bulk transmission also in the first stage and thus involves process SS4 in the sending mail server. This process consists of the trivial operation of transmitting the message with the multi-media data, as received from the sending mail client, unchanged. Thus, it is the conventional process in an e-mail server.

Process SC1 in the sending mail client, generating an e-mail message with MMC in reference mode, operates in one of the following two manners. First, when a multi-media generation process is ready to begin, the sending mail client, on command from the user, conveys to the streaming client the addresses of a streaming server and of a media store and a signal to start the process. Thereupon, the streaming client contacts the streaming server and begins streaming multi-media data up to the media store. Upon termination of the process, the location of the data in the store, as well as the type and format of the data (if not constant for that particular node), are conveyed to the sending mail client, which generates an e-mail message (unless already prepared beforehand) and imbeds or attaches thereto the URI of the data storage and the type and format of the data, then sends it on to the sending mail server.

The second manner in which process SC1 in the sending mail client, generating an e-mail message with MMC in reference mode, operates, is that on command from the user, the streaming client obtains from the sending mail client addresses of a streaming server and of a media store (unless it already knows them), then contacts the streaming server and begins streaming multi-media data up to the media store Upon termination of the process, the location of the data in the store, as well as the type and format of the data (if not constant for that particular node), are automatically conveyed to the sending mail client, which generates an e-mail message (or opens one, if already generated) and automatically imbeds or attaches thereto the URI of the data storage and the type and format of the data, then sends it along to the sending mail server.

The various configurations may serve different sets of requirements and capabilities in the system and in the various nodes. Each of the four configurations described above (all involving process RC1) will now be discussed in a coherent manner and in terms of these requirements and capabilities.

Configuration A, involving processes SC1, SS1 and RS1, enables both the sending client and the receiving client to operate in streaming fashion and, moreover, frees the entire e-mail system from carrying the actual multi-media data, which usually is quite voluminous. This latter characteristic, which is advantageous, entails some further requirements and capabilities of the system, namely an ability to manage the stored multi-media data. Such management includes the functions of securing the data from unauthorized access and of tracking and limiting the storage lifetime of any stored file. These capabilities are referred to as support for inter-server references. An additional optional function is transferring the data, in bulk, from one media store to another, so as to utilize available capacities or to provide optimal transmission bandwidth between the various media stores and the respective streaming clients; any such transfer requires, of course, suitable change in the reference data. The above-described functions are known to those skilled in the art, and it is only a matter of economics and logistical considerations in deciding whether to include this configuration in any particular system.

Similarly, configuration B, involving processes SCi, SS2 and RS2, enables both the sending client and the receiving client to operate in streaming fashion. However, configuration B obviates the necessity for inter-server storage management (discussed above with respect to configuration A), by providing bulk transmission of the MMC between the mail servers (i.e. at the second stage). This has the disadvantage of high inter-server data volume. Fortunately, for many systems this disadvantage may be insignificant.

Both configuration C and configuration D serve to deliver MMC that originates as bulk data to the receiving node in streaming fashion. Configuration C, which includes reference mode transmission between the mail servers and thus involves processes SC2, SS3 and RS1, shares with configuration A the advantage of light inter-server traffic, as well as some of the storage management requirements discussed above. Configuration D, which includes bulk mode transmission between the mail servers and thus involves processes SC2, SS4 and RS2, shares with configuration B the lack of need for inter-server storage management and the heavier inter-server traffic.

It is noted that the invention, particularly in configurations A and C, is also applicable, with obvious modifications, to MMC that are not based on time and thus do not benefit from streaming. The advantage of using the invention would then lie in freeing the e-mail system from the burden of the bulky multi-media data when messages are transmitted in reference mode over some or all of the transmission stages.

Another configuration according to the invention, involving processes SC1, SS2, RS3 and RC2, will be referred to as configuration E. This configuration serves to enable a sending terminal to upstream multi-media data, in conjunction with an e-mail message, and to deliver them to a receiving terminal in a conventional, i.e. bulk mode, manner. Configuration E is thus suitable for multi-media e-mail transmission cases where it is convenient for the originator to send the MMC in streaming fashion and in which the receiver has only conventional e-mail client and media player. Processes SC1 and SS2 have been described above. Process RS3 consists of the trivial (and conventional) operation of transmitting the e-mail message (including the attached multi-media data) unchanged. Process RC2 represents the capabilities of a conventional e-mail client. It is noted that process SS2 could also be resident in the receiving mail server, obtaining the message in reference mode from the sending mail server (utilizing process SS1). Such a configuration is however deemed less practical, for reasons already outlined above with respect to configuration C. It is further noted, by way of clarification, that a configuration involving processes SC2, SS4, RS3 and RC2 is exactly the conventional configuration.

A system, or any node therein, may be set up to operate in any one of the above configurations or in several of them. Thus, for example, a sending mail server may comprise capabilities for any or all of the corresponding processes mentioned (SS1 to SS4). When set up for more than one configuration, the contents of the message specifies which process is to be used. A sending mail client may decide between processes SC1 and SC2 according to the type and/or format of the media, or the availability of a suitable streaming server. A receiving mail client decides simply on the basis of whether the message contains a reference to a media store. If it does, process RC1 is activated. Otherwise, process RC2 (conventional) is followed.

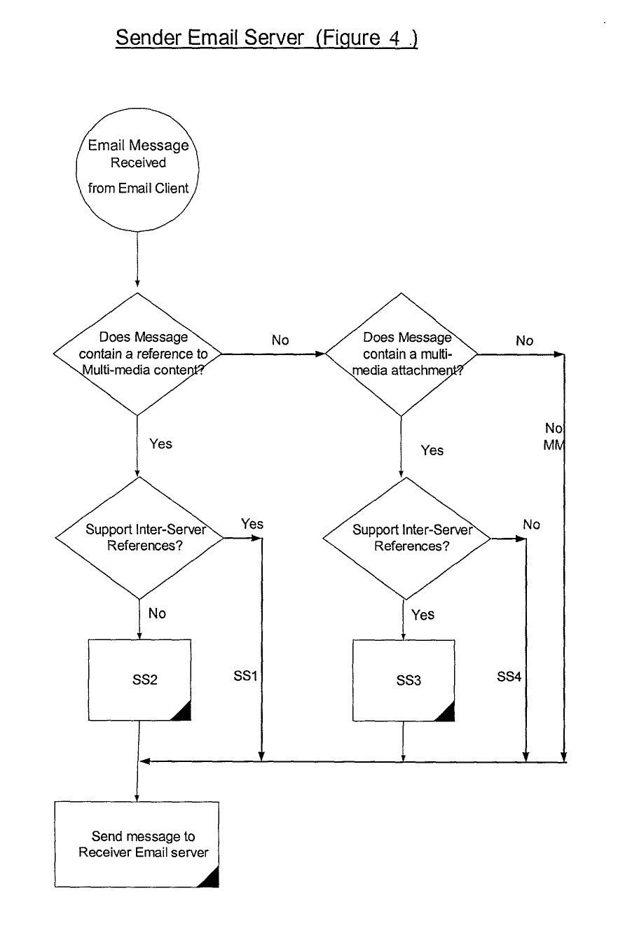

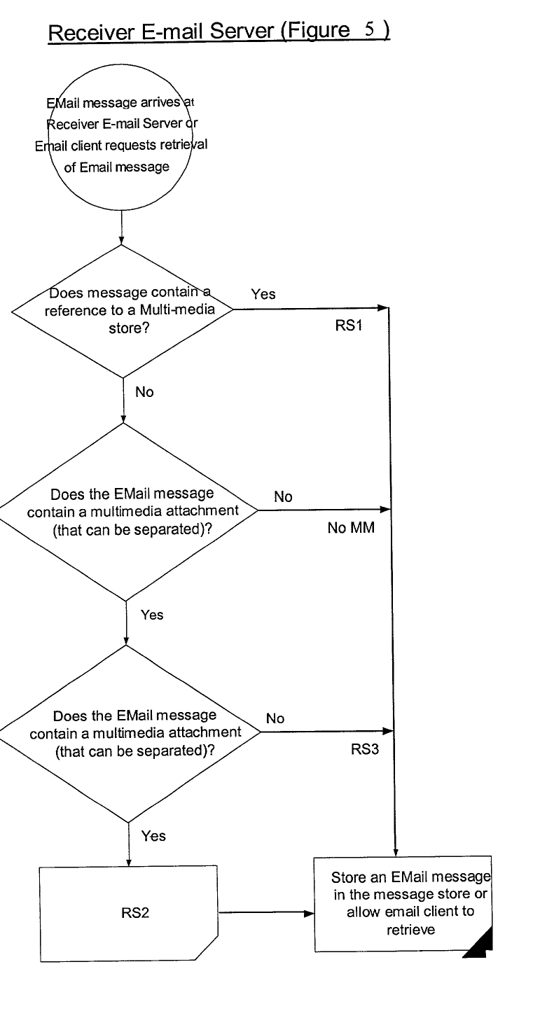

A typical procedure for decision between the processes in the e-mail servers is depicted in the flow diagrams of FIG. 3. FIG. 4 shows a typical procedure in the sending mail server. Here, an e-mail message received from the sending mail client is examined as to whether it contains a reference to a media store or else whether it contains a multi-media carrying attachment (i.e. per conventional or bulk mode transmission). Another criterion is whether the server or the system support inter-server reference mode transmission; that is, whether they provide storage management for the multi-media data (including security and lifetime management), as discussed above with respect to configuration A. In the positive case, the MMC contents are forwarded to the receiving mail server in reference mode. Otherwise, this is done in bulk mode. The processes are indicated by the same symbols as in FIGS. 2 and 3. Note that SS1 and SS4 are, in effect, dummy processes, which do not affect the contents of the messages. FIG. 5 shows a typical procedure in the receiving mail server. Here, an e-mail message received from the sending mail server is, again, examined as to whether it contains a reference to a media store or else whether it contains a multi-media carrying attachment (bulk mode). In the latter case, process RS2 is employed, to convert the message to reference mode, subject to the criterion of whether such a conversion or such a mode is enabled or allowed. This latter criterion, in turn, depends largely on whether the receiving mail client is ready to accept the MMC in streaming fashion, either permanently or just for the particular message—which readiness may be known by the mail server or conveyed to it prior to transmission. Note that in all other cases the message is, again, forwarded unchanged and that RS1 and RS3 are, in effect, dummy processes.

All processes and procedures described above are preferably realized as software programs in their respective nodes. These programs may be independent packages, cooperative with their respective clients or servers (which usually also are software programs), or they may be integrated with the respective clients or servers, to form proprietary modified versions thereof. In another aspect, an e-mail system, or any component thereof, such as an e-mail client or an e-mail server, that is functional according to any of the configurations described, should be regarded as a novel type of a system or a component, respectively, according to the invention.

1. A method for sending multi-media contents, in association with an e-mail message, from a sending terminal over a network to a receiving terminal, wherein the receiving terminal includes a receiving e-mail client and a streaming client and the network is also communicative with at least one media store; the method comprising:
(a) sending the e-mail message from the sending terminal;
(b) storing the multi-media contents at a location in a media store;
(c) embedding in the e-mail message a reference to said location;
(d) receiving the e-mail message at the receiving terminal; and
(e) causing the receiving e-mail client, after receiving the message, to extract said reference therefrom and to automatically activate the streaming client so as to address said media store according to the extracted reference and to transfer the corresponding multi-media contents from said media store in a streaming fashion.

2. The method of claim 1, wherein (b) and (c) are each performed by the sending terminal.

3. The method of claim 1, wherein the e-mail message is transmitted through at least one e-mail server, communicative with the network, and (b) and (c) are each performed by an e-mail server.

4. The method of claim 1, wherein, in (e), said transferring is by means of a streaming server communicative with the network and selectable by the receiving client.

5. A method for sending multi-media contents, in association with an e-mail message, from a sending terminal over a network to a receiving terminal, the network being also communicative with at least one media store; the method comprising:
(a) sending the multi-media contents from the sending terminal in a streaming fashion to a media store, to be stored at a location therein;
(b) at the sending terminal automatically embedding in the e-mail message a reference to said location of (a);
(c) sending the e-mail message from the sending terminal;
(d) receiving the e-mail message at the receiving terminal;
(e) at the receiving terminal automatically extracting from the received e-mail message a reference to a location in a media store; and
(f) automatically causing the multi-media contents to be sent from the media store referred to by the extracted reference of (e), to the receiving terminal in a streaming fashion.

6. The method of claim 5, whereby the sending terminal includes an e-mail client and wherein (a) and (b) are performed upon command from the e-mail client.

7. The method of claim 5, wherein, in (a), said sending the multi-media contents is by means of any streaming server communicative with the network.

8. The method of claim 5, wherein, in (f), the multi-media contents is sent by means of any streaming server communicative with the network.

9. A method for sending multi-media contents, in association with an e-mail message, from a sending terminal over a network to a receiving terminal, wherein the e-mail message is transmitted through at least one e-mail server and the network is also communicative with at least one media store, the method comprising:
(a) at the sending terminal, embedding the multi-media contents in the message or attaching the multi-media contents to the message;
(b) sending the e-mail message, with the multi-media contents embedded or attached thereto, from the sending terminal;
(c) causing an e-mail server that receives the message of (a) to extract the multi-media contents therefrom, to store the extracted contents at a location in a media store and to embed in the e-mail message a reference to said location;
(d) receiving the e-mail message at the receiving terminal;
(e) at the receiving terminal automatically extracting from the received e-mail message a reference to a location in a media store; and automatically causing the multi-media contents to be sent from the media store referred to by the extracted reference of (e), to the receiving terminal in a streaming fashion.

10. The method of claim 9, wherein (b) additionally includes causing the e-mail server to convert the format of the multi-media contents.

11. The method of claim 9, wherein, in (d), the multi-media contents are sent by means of a streaming server communicative with the network and automatically selected by the receiving terminal.

12. A method for sending multi-media contents, in association with an e-mail message, from a sending terminal over a network to a receiving terminal, wherein the e-mail message is transmitted through at least one e-mail server and the network is also communicative with at least one media store, the method comprising:
(a) sending the multi-media contents from the sending e-mail client in a streaming fashion to a media store, to be stored at a location therein;
(b) at the sending terminal automatically embedding in the e-mail message a reference to said location;
(c) sending the e-mail message from the sending terminal;
(d) causing an e-mail server that receives the e-mail message with said embedded reference to extract said reference therefrom, to automatically transfer from said media store the multi-media contents corresponding to the extracted reference and to attach said multi-media contents to the message; and
(e) receiving the e-mail message, with the attached multi-media contents, at the receiving terminal.

13. The method of claim 12, whereby the sending terminal includes an e-mail client, and wherein (a) and (b) are performed upon command from the e-mail client.

14. The method of claim 13, wherein, in (a), said sending the multi-media contents is by means of a streaming server communicative with the network and selectable by said e-mail client.

15. The method of claim 12, wherein (c) additionally includes causing the e-mail server to convert the format of the multi-media contents.

16. A digital device, for sending therefrom multi-media contents, in association with an e-mail message, over a network, with which it communicates, the network being also communicative with at least one media store, the device comprising a streaming client and an e-mail client that is configured to:
cooperate with the streaming client in transferring the multi-media contents from the device in a streaming fashion to a media store, to be stored at a location therein; and
automatically embed in the e-mail message a reference to said location.

17. The device of claim 16, wherein said e-mail client is further configured to issue a command to said streaming client, which command causes the streaming client to address a media store and to send the multi-media contents thereto in a streaming fashion.

18. The device of claim 16, further comprising a plurality of streaming servers communicative with the network, wherein said e-mail client is further configured to select one of the streaming servers for cooperating with the selected streaming server in transferring the multi-media contents.

19. A digital device, for receiving multi-media contents, in association with an e-mail message, over a network, with which it communicates, the multi-media contents being stored at a location in a media store communicative with the network, and the message including a reference to the location in the media store, the device comprising a streaming client and an e-mail client that is configured to automatically extract the reference from the e-mail message, said e-mail client being further configured to cause the streaming client to receive the multi-media contents from the media store, according to said extracted reference, in a streaming fashion.

20. A computing device, communicative with a network, for forwarding an incoming e-mail message in association with multi-media contents, the multi-media contents being stored at a location in a media store communicative with the network and the incoming message including a reference to the location in the media store, the device comprising:
a message input module, for receiving the incoming e-mail message;
a processor, cooperative with said input module and configured to automatically
extract the reference from the incoming message,
cause the multi-media contents to be transferred from the media store, according to the extracted reference, to the device,
attach the transferred multi-media contents to the message, and
forward the message with the attached multi-media contents; and
a message output module, responsive to said processor and configured to send along the e-mail message with any multi-media contents attached thereto.

21. The device of claim 20, wherein said processor is further configured to convert the format of the multi-media contents.

22. A computing device, communicative with a network, for forwarding an incoming e-mail message in association with multi-media contents, the multi-media contents being attached to the incoming message and the network being also communicative with at least one media store, the device comprising:
a message input module, for receiving the incoming e-mail message;
a processor, cooperative with said input module and configured to automatically
separate the multi-media contents from the incoming message, to form a multi-media data file,
transfer said data file to a location in a media store,
attach to, or imbed in, the message that remains after said separation a reference to said location, and
forward the message with said reference; and
a message output module, responsive to said processor and configured to send along the e-mail message with any reference imbedded therein.

23. The device of claim 22, wherein said processor is further configured to convert the format of the multi-media contents.

24. A computer program product comprising a computer useable medium having computer readable program code embedded therein for sending multi-media contents, in association with an e-mail message, from a terminal out over a network, wherein the terminal includes a streaming client and the network is also communicative with at least one media store, the computer program product comprising:
computer readable program code for causing the streaming client to transfer the multi-media contents from the terminal in a streaming fashion to a media store, to be stored at a location therein;
computer readable program code for automatically obtaining a reference to said location and embedding said reference in the e-mail message; and
computer readable program code for sending out the e-mail message with the embedded reference.

25. The computer program product of claim 24, wherein the terminal also includes an e-mail client, and wherein said causing the streaming client includes sending a command from the e-mail client to the streaming client and said embedding is carried out by the e-mail client.

26. The computer program product of claim 24, further comprising a plurality of streaming servers communicative with the network, wherein (a) includes selecting one of the streaming servers to cooperate with the streaming client in transferring the multi-media contents.

27. A computer program product comprising a computer useable medium having computer readable program code embedded therein for receiving multi-media contents, in association with a received e-mail message, from a network by a terminal, wherein the multi-media contents are stored at a location in a media store communicative with the network, the message includes a reference to the location in the media store, and the terminal includes a streaming client, the computer program product comprising:
computer readable program code for automatically extracting the reference from the received e-mail message; and
computer readable program code for automatically causing the streaming client to address the media store according to the extracted reference and to have the multi-media contents transferred therefrom to the device in a streaming fashion.

28. The computer program product of claim 27, wherein the terminal also includes an e-mail client, and wherein said extracting is carried out by the e-mail client and said causing the streaming client includes sending a command from the e-mail client to the streaming client.

29. The computer program product of claim 27, further comprising a plurality of streaming servers communicative with the network, and further including computer readable program code for selecting one of the streaming servers to cooperate with the streaming client in transferring the multi-media contents.

30. A computer program product for use in an e-mail server communicative with a digital network including a computer useable medium having computer readable program code embedded therein for forwarding an incoming e-mail message in association with multi-media contents, the multi-media contents being stored at a location in a media store, communicative with the network, and the incoming message including a reference to said location, the computer program product comprising:
computer readable program code for automatically extracting the reference from the incoming message;
computer readable program code for automatically addressing the media store, according to the reference, and causing the multi-media contents to be transferred therefrom to the server;
computer readable program code for automatically attaching the multi-media contents to the message; and
computer readable program code for forwarding the message with the attached multi-media contents.

31. The computer program product of claim 30, further comprising computer readable program code for converting the format of the multi-media contents.

32. A computer program product for use in an e-mail server communicative with a digital network including a computer useable medium having computer readable program code embedded therein for forwarding an incoming e-mail message in association with multi-media contents, the multi-media contents being attached to the incoming message and the network being also communicative with at least one media store, the computer program product comprising:
computer readable program code for automatically separating the multi-media contents from the incoming message, to form a multi-media data file;
computer readable program code for automatically transferring said data file to a location in a media store;
computer readable program code for automatically attaching to, or imbedding in, the message that remains after said separation a reference to said location; and
computer readable program code for forwarding the message with said reference.

33. The computer program product of claim 32, further comprising computer readable program code for converting the format of the multi-media contents.

34. A computer program product comprising a computer useable medium having computer readable program code embedded therein for sending multi-media contents, in association with an e-mail message, from a sending terminal over a digital network to a receiving terminal, the network being also communicative with at least one media store, the computer program product further comprising:
computer readable program code for sending the multi-media contents from the sending terminal in a streaming fashion to a media store, to be stored at a location therein;
computer readable program code for automatically embedding in the e-mail message, at the sending terminal, a reference to said location;
computer readable program code for automatically extracting from a received e-mail message, at the receiving terminal, a reference to a location in a media store; and
computer readable program code for automatically causing the multi-media contents to be sent from the media store, referred to by said extracted reference, to the receiving terminal in a streaming fashion.

35. The method of claim 5, wherein there are at least two e-mail servers communicative with the network, the method further comprising:
(a) causing a first e-mail server, upon receiving an e-mail message with said embedded reference, to extract said reference therefrom, to automatically transfer from said media store the multi-media contents corresponding to the extracted reference, to attach said multi-media contents to the message and to send said message with the attached multi-media contents onward.
(b) causing a second e-mail server, upon receiving an e-mail message with attached multi-media contents, to extract the multi-media contents therefrom, to store the extracted contents at a location in a media store, to embed in the e-mail message a reference to said location and to send the message with said embedded reference onward.
